(19) United States
(12) Patent Application Publication
(10) Pub. No.: US 2022/0396031 A1
(43) Pub. Date: Dec. 15, 2022

(54) 3D PRINTING MODULES TO GENERATE CLEANING STREAMS

(71) Applicant: HEWLETT-PACKARD DEVELOPMENT COMPANY, L.P., Spring, TX (US)

(72) Inventors: Pablo Antonio Murciego Rodriguez, Sant Cugat del Valles (ES); Ruben Prats Gonzalez, Sant Cugat del Valles (ES); Arturo Garcia Gomez, Sant Cugat del Valles (ES)

(21) Appl. No.: 17/755,034

(22) PCT Filed: Jan. 29, 2020
(86) PCT No.: PCT/US2020/015531

§ 371 Date: Apr. 19, 2022

(51) Int. Cl. B29C 64/35; B29C 64/245; B29C 64/232

(52) U.S. Cl. CPC B29C 64/35; B29C 64/245; B29C 64/232; B33Y 40/20

(57) ABSTRACT

A 3D printing module to remove un-solidified build material attached to a 3D printed part is disclosed herein. The 3D printing module comprises a platform within a housing to support a 3D printed part, a vibrating mechanism to vibrate the platform, a cleaning element to apply a cleaning stream within the housing to clean the 3D printed part, and a controller. The controller is to vibrate the platform, generate a cleaning stream in the housing, and to control at least one of the platform and the cleaning element to apply the cleaning stream to different portions of a 3D printed part on the platform.

### BACKGROUND

Some additive manufacturing or three-dimensional printing systems generate 3D objects by selectively solidifying portions of successively formed layers of build material in a layer-by-layer manner. At the end of the 3D printing process, un-solidified portions of build material may be separated from the generated objects.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printing module.

FIG. 2 is a flowchart of an example method of removing un-solidified build material in the 3D printing module.

FIG. 3A is another schematic diagram showing an example of a 3D printing module.

FIG. 3B is another schematic diagram showing an example of a 3D printing module.

FIG. 3C is another schematic diagram showing an example of a 3D printing module.

FIG. 4 is a schematic diagram showing an example of a cleaning element configuration in a 3D printing module.

FIG. 5 is a schematic diagram showing an example of a 3D printing module with a tilting mechanism.

FIG. 6A is a schematic diagram showing an example of first stage of a cleaning process of a 3D printing module.

FIG. 6B is a schematic diagram showing an example of a second stage of a cleaning process of a 3D printing module.

FIG. 7 is a flowchart of another example method for removing un-solidified build material from the 3D printing module.

### DETAILED DESCRIPTION

The following description is directed to various examples of additive manufacturing, or three-dimensional printing, apparatus and processes to generate 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printing systems generate a 3D object by executing a series of 3D printing operations. In some 3D printing systems, some of the 3D printing operations are distinct from each other and may be executed by different sub-systems of the 3D printing system. The sub-systems may be different depending on the type of material and 3D printing technology used. Some sub-systems may be physically placed at different locations. Other sub-systems may be integrated into a single housing.

Some 3D printers generate 3D objects by selectively processing layers of build material. For example, a 3D printer selectively solidifies portions of a layer of build material corresponding to a slice of a 3D object to be generated, thereby leaving the portions of the layer un-solidified in the areas where no 3D object is to be generated. The combination of the generated 3D objects and the un-solidified build material is commonly referred to as build bed. The volume in which the build bed is generated is commonly referred to as a build chamber.

Suitable powder-based build materials for use in additive manufacturing may include, where appropriate, at least one of polymers, metal powder or ceramic powder. In some examples, build materials may be provided in other forms, such as gels, pastes, and slurries.

3D printing systems may additionally execute cleaning operations to separate the generated 3D printed parts from the un-solidified build material. In some examples, the cleaning operations may be performed in the 3D printer. In other systems, the entire build bed is transferred to a cleaning apparatus where the cleaning operations are executed. In some systems, a first cleaning operation may be performed in a first cleaning module (e.g., 3D printer) and a second cleaning operation may be performed in a second cleaning module (e.g., cleaning apparatus).

These cleaning operations may be executed within an enclosed receptacle in which the build bed is contained. These receptacles are small in size and do not have much room for conveyance of the build bed as a whole, as opposed to industrial processes with large conveying belt systems. Some of the examples of 3D printing modules herein separate un-solidified build material from the 3D printed parts (i.e., clean the 3D printed parts from the un-solidified build material) in an automated manner and within the volume in which the build bed is located thereby inhibiting airborne build material during the cleaning operation.

In some systems, a removable receptacle suitable to contain the build bed, may be attached and detached from the different sub-systems of the 3D printing system. In some systems the removable receptacle is a build unit. A build unit may be a module that includes a build chamber in which 3D objects are to be generated throughout the 3D printing process of the 3D printing system.

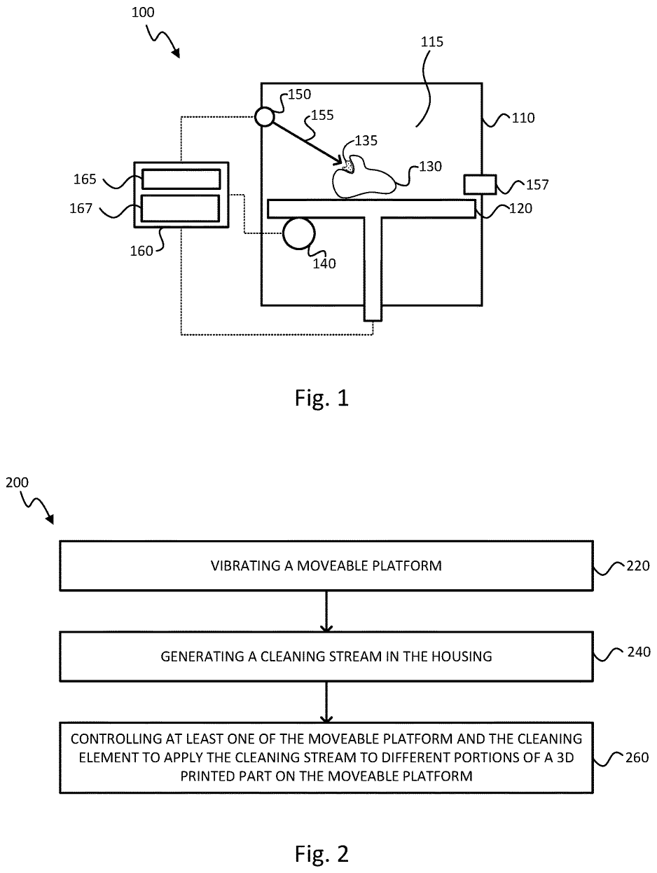

Referring now to the drawings, FIG. 1 is a schematic diagram showing a vertical cross-section of a 3D printing module 100 according to an example. The 3D printing module 100 may, for example, be part of a build material processing station, a 3D printer, a cleaning station, or the like.

The 3D printing module 100 comprises a housing 110. The housing 110 is a receptacle defining a chamber 115 in which is located a platform 120. The platform 120 may span substantially a full horizontal surface of the chamber 115. In some examples, the platform 120 may be moveable within the chamber 115 (e.g., vertically), through for example a platform driving mechanism (not shown).

In the examples in which the 3D printing module 100 is included in a 3D printer, the chamber 115 may be referred to as a build chamber. The build chamber enables the generation of layers of build material to be formed on the platform 120. In some examples, portions of the newly formed uppermost layer of build material may be selectively solidified (or partially solidified) to form a layer comprising at least a part of a 3D printed object 130 that is being generated. Upon the completion of the 3D object generation process, a cleaning operation to separate the 3D printed part 130 and the un-solidified build material is performed.

In some examples, however, the 3D printing module 100 is included in a cleaning station which is not integrated into the 3D printer. In these examples, the build bed is generated in the 3D printer and is then transferred to the cleaning station through, for example, a transportation unit (not shown). The transportation unit may be understood as an enclosure suitable to hold a build bed and engageable with the cleaning station. In an example, upon completion of the build bed generation, the build bed is transferred to a transportation unit. In another example, the build bed is directly generated in a transportation unit within the 3D printer and, upon completion of the generation of the 3D object 130, the transportation unit with the build bed therein is transferred to the cleaning station. The transportation unit with a build bed therein is engageable with the cleaning station in such a way that the build bed can be transferred from the inner volume of the transportation unit to the top surface of the platform 120. In these examples, the cleaning operation is executed in the cleaning station.

The un-solidified build material in direct contact or in close proximity of the generated 3D printed objects (referred hereinafter as attached build material) may be harder to separate than other portions of un-solidified build material (referred hereinafter as loose build material). This may be caused, for example, because this build material additionally comprises some printing agents and/or may have been influenced by the thermal bleed caused during the generation of the 3D objects.

In additional examples, a first cleaning operation is executed in the 3D printer and a second cleaning operation is executed in the cleaning station. The first cleaning operation may be used to remove a first portion of un-solidified build material (e.g., loose build material) and the second cleaning operation may be used to remove a second portion of un-solidified build material (e.g., attached build material).

The platform 120 is controllable to move vertically within the chamber 115. In an example, the platform 120 is to move reciprocally upwards and downwards. In an example, the platform 120 is to move reciprocally upwards and downwards for a distance corresponding to the full height of the chamber. In another example, the platform 120 is to move reciprocally upwards and downwards for a distance from the range of 0 and 150 mm, for example 100 mm. In another example, the platform 120 is to move reciprocally upwards and downwards for a distance from the range of 0 to 75 mm, for example 50 mm. In yet another example, the platform 120 is to move reciprocally upwards and downwards for a distance of less than 50 mm.

The 3D printing module 100 further comprises a vibrating mechanism 140 to vibrate the moveable platform 120. The vibrating mechanism 140 may vibrate and thereby transfer the vibration to the platform 120. The vibration is therefore transmitted as energy to the build bed. Some of the un-solidified build material may reside in the chamber 115 in an agglomerated manner, thereby being harder to remove from the chamber. The vibration may loosen and/or break-up agglomerated build material allowing such build material to be removed out of the 3D printing module 100 by, for example, a sieve and/or a pneumatic extraction system (not shown). The vibration of the build platform 120 provides a vertical displacement of the 3D printed parts 130 with un-solidified build material 135 attached thereto allowing such build material to be removed. In additional examples, the vibration of the build platform 120 provides a lateral displacement as well.

The vibrating mechanism 140 may be controlled to vibrate at a specific frequency or range of frequencies. In an example, the vibrating mechanism 140 vibrates to cause the platform 120 to vibrate at a fixed frequency. In another example, the vibrating mechanism 140 vibrates to cause the platform 120 to vibrate at a plurality of fixed frequencies spaced apart by a predetermined period (e.g., vibrating at a first frequency for a period of time followed by vibrating at a second frequency for a period of time). In yet further example, the vibrating mechanism 140 vibrates to cause the platform 120 to vibrate at a set of frequencies ranging from a lower end frequency to a higher end frequency.

In an example, the vibrating mechanism 140 may cause the platform 120 to vibrate at a frequency ranging from 20 to 60 Hz, for example 30 Hz or 50 Hz. In another example, the vibrating mechanism 140 may cause the platform 120 to vibrate at a frequency ranging from 40 to 50 Hz.

The 3D printing module 100 also comprises a cleaning element 150 to apply a cleaning gas stream 155 within the housing to clean the 3D printed part 130. The cleaning element 150 may be any device suitable for generating and applying a cleaning stream 155, for example, a blowing nozzle, a microturbine, a dry ice generator or a bead blasting device. In one example, the cleaning element 150 is an airknife. In the example in which the cleaning element 150 is a dry ice generator, there may be a previous chamber in which a block of dry ice is sublimated to form a cold gas stream which is to be directed to the chamber 115 as a cleaning stream 155. An airknife is a tool used to generate a uniform sheet of laminar airflow. An example of an airknife is formed by a plurality of air nozzles located one next to each other in a linear way. Another example of an airknife is formed by a narrow and generally relatively long air port.

The cleaning element 150 may be mounted or attached to a wall of the chamber 115. The cleaning element 150 may be positioned towards a top portion of the housing and, when in use, above the platform 120 to generate the cleaning stream 155 generally towards the platform 120. The cleaning stream 155 is intended to reach and remove the attached un-solidified build material 135 from any the 3D printed parts positioned on the platform 120 and thereby clean the 3D printed parts. For simplicity, only a single 3D printed part 130 is shown in FIG. 1.

In an additional example, the cleaning element 150 is controllable to generate the cleaning stream 155 in a rotatable manner. In an example, the cleaning element 150 is rotatable to vary the angle at which the stream hits objects 130. In another example, the cleaning element 150 may be fixed but additionally comprises a shutter (not shown) to modify the cleaning stream 155 orientation without rotating the cleaning element 150 itself.

The 3D printing module 100 may additionally comprise a build material removal system 157 to transfer the removed un-solidified build material from the cleaning operation to a reservoir outside of the chamber 115. In an example, the build material removal system 157 is a pneumatic build material extraction device (e.g., fan).

The 3D printing module 100 further comprises a controller 160. The controller 160 comprises a processor 165 and a memory 167 with specific control instructions to be executed by the processor 165. The controller 160 is coupled to the vibrating mechanism 140 and the cleaning element 150. Additionally, the controller 160 may further be coupled to the platform 120. The controller 160 may control the operations of the cleaning element 150, the vibrating mechanism 140 and, additionally, the platform 120. The functionality of the controller 160 is described further below.

In the examples herein, a controller may be any combinations of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller may be a distributed controller, a plurality of controllers, and the like.

FIG. 2 is a flowchart of an example method for removing un-solidified build material from 3D printed objects on the platform 120 in the 3D printing module, for example, the 3D printing module 100 from FIG. 1. In some examples, method 200 may be executed by the controller 160.

Method 200 may be started when at least one 3D printed part with un-solidified build material attached thereto is placed on the platform 120 in the 3D printing module 100. In another example, method 200 may be started when a full build bed is placed on the platform 120.

At block 220, the controller 160 controls the vibrating mechanism to vibrate and thereby cause the platform 120 to vibrate at a predetermined frequency or range of frequencies. The vibration of the platform 120 causes the 3D printing parts 130 to displace laterally and vertically. The vertical displacement of the 3D printed parts 130 may remove, at least in part, the un-solidified build material 135 attached thereto. In an additional example, when a full build bed is placed on the platform 120, the platform 120 vibration may loosen and/or break up un-solidified build material structures so that a build material removal system 157 (e.g., an external pneumatic build material extraction device) transfers the build material to an external build material tank or hopper.

At block 240, the controller 160 controls the cleaning element 150 to generate a cleaning stream 155 in the chamber 115. The controller 160 controls the cleaning element 150 to apply the cleaning stream 155 in a predetermined manner. For example, the controller 160 controls the cleaning element 150 to generate the cleaning stream 155 as a series of pulses in a predetermined period (e.g., sequences of a first period with an active cleaning stream 155 and a second period without cleaning stream). In another example, the controller 160 controls the cleaning element 150 to generate the cleaning stream 155 as a sequence of higher and lower intensity cleaning streams (e.g., sequences of a first period with a higher intensity cleaning stream 155 and a second period with a lower intensity cleaning stream 155). In yet another example, the controller 160 controls the cleaning element 150 to generate the cleaning stream 155 as a sequence of increasing intensity, i.e. from a lower intensity to a higher intensity, and decreasing intensity, i.e. from a higher intensity to a lower intensity (e.g., cleaning stream 155 as sequences of a first period with a ramp up of intensities and a second period with a ramp down of intensities).

At block 260, the controller 160 is to control at least one of the platform 120 and the cleaning element 150 to apply the cleaning stream 155 to different portions of a 3D printed part 130 on the platform 120. The controller 160 may control the platform 120 to move vertically for a distance to re-orientate the 3D printed part 130 with respect to the cleaning stream 155 so that the cleaning stream 155 accesses different portions of the 3D printed part 130 and thereby removes un-solidified build material 135 attached to the different portions that the cleaning stream 155 has been directed to. The controller 160 may also control the cleaning element 150, or any apparatus engageable with the cleaning element 150 and the cleaning stream 155 (e.g., shutter), to re-orientate the cleaning stream 155 to be directed towards different portions of the 3D printed part 130 and thereby remove un-solidified build material 135 attached to the different portions that the cleaning stream 155 has been directed to. In an example, the controller may control the cleaning element 150 or the apparatus engageable thereto to move vertically, laterally, or to rotate.

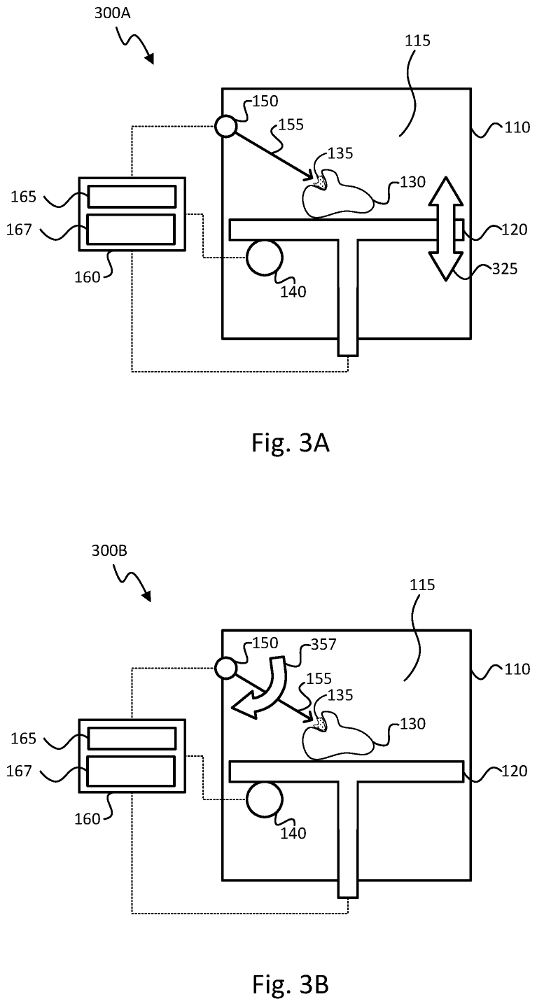

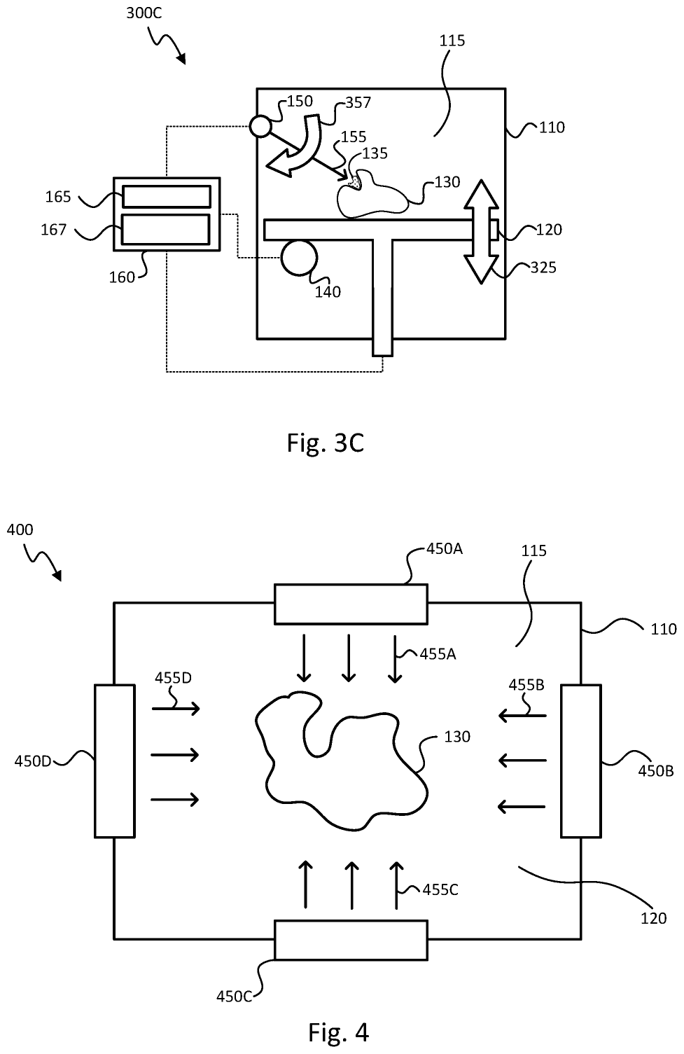

FIGS. 3A-C illustrate example implementations of the 3D printing module (e.g., 3D printing module 100 from FIG. 1) that involve previously disclosed elements from FIG. 1 referred to with the same reference numerals. The 3D printing modules disclosed in FIGS. 3A-C comprise the housing 110, the platform 120, the vibrating mechanism 140, the cleaning element 150, and the controller 160.

FIG. 3A is shows a 3D printing module 300A according to an example. In the example, the cleaning element 150 is fixed with respect to the chamber 115. The cleaning stream 155 is also fixed with respect to the chamber 115, thereby the angle between the cleaning stream 155 and a horizontal axis is constant.

In the example, platform 120 is a moveable platform controllable by the controller 160. The controller 160 is to control the platform 120 to move vertically (e.g., along illustrated arrow 325) during a cleaning operation. The vertical movement of the platform 120 enables the 3D printed part 130 to change orientation with respect to the fixed cleaning stream 155, so that the fixed cleaning stream 155 accesses different portions of the 3D printed part 130 surface and thereby removes the un-solidified build material 135 from the different portions of the 3D printed part 130 surface.

In an example, the start position of the platform 120 may be at a lower part of the chamber 115, the controller 160 is then to move the platform 120 vertically upwards in a single pass throughout the cleaning operation. In another example, the start position of the platform 120 may be at a higher part of the chamber 115, the controller 160 is then to move the platform 120 vertically downwards in a single pass throughout the cleaning operation. In another example, the controller 160 is to move the platform 120 vertically downwards and vertically upwards, both in a single pass, throughout the cleaning operation. In yet another example, the controller 160 is to move the platform 120 reciprocally upwards and downwards in a plurality of passes throughout the cleaning operation.

The example shown in FIG. 3B is described with reference to a 3D printing module 300B. In an example, the platform 120 is a fixed platform with respect to the housing 110. In another example, the platform 120 is a moveable platform, in which the controller 160 is to move the platform 120 to a predetermined position with respect to the cleaning element 150 and/or the housing 110 before the cleaning operation. Once the platform 120 is in the predetermined position, the controller 160 controls the other elements from the 3D printing module 300B to start the cleaning operation.

In the example, however, the cleaning stream 155 is controlled to move in a rotatable manner (e.g., rotatable along the illustrated arrow 357). In an example, the cleaning element 150 is rotatable and therefore the cleaning stream 155 is to rotate similarly as the cleaning element 150 that generates it. In another example, the cleaning element 150 is fixed with respect to the housing 110 but a shutter (not shown) may be used to control the orientation of the cleaning stream 155. Therefore, controlling the rotation of the shutter leads to a cleaning stream 155 rotation control as well.

Controlling the cleaning stream 155 to move in a rotatable manner while the platform 120 is maintained in the predetermined position, causes the cleaning stream 155 to be applied to different parts of the 3D printed part 130 during the cleaning operation. Therefore, the cleaning stream 155 reaches different parts of the 3D printed part and removes un-solidified build material 135 located thereto.

The example from FIG. 3C is disclosed with reference to a 3D printing module 300C. The platform 120 is a moveable platform and is controlled to move in a similar way as the moveable platform 120 disclosed in FIG. 3A. Similarly, the cleaning stream 155 is also controlled to move and/or rotate in a similar way as the cleaning stream 155 disclosed in FIG. 3B.

In an example, the platform 120 is controlled to move to a position with respect to the housing 110 and the cleaning stream 150 is to rotate according to one of the examples disclosed above (see, e.g., FIG. 3B). Then, the platform 120 is controlled to move to a different position with respect to the housing 110 and the cleaning stream 150 is to rotate similarly. This cleaning method may be executed repeatedly or similarly by moving the platform 120 to different position during the cleaning operation.

In another example, the cleaning stream 155 is controlled to be fixed at a first angle with respect to a horizontal axis and the platform 120 is controlled to move according to one of the examples disclosed above (see, e.g., FIG. 3A). Sequentially, the cleaning stream 155 is controlled to be fixed at a second different angle with respect to the horizontal axis and the platform 120 is controlled to move similarly. This cleaning method may be executed repeatedly or similarly by positioning the cleaning stream 155 at different angles with respect to the horizontal axis during the cleaning operation.

In yet another example, the platform 120 is controlled to move as disclosed in at least one of the examples from FIG. 3A and the cleaning stream 150 is disclosed to rotate as disclosed in at least one of the examples from FIG. 3B at the same time. This cleaning method may be executed repeatedly during the cleaning operation.

By executing the above examples, the cleaning stream 155 is applied to different parts of the 3D printed part 130 during the cleaning operation, thereby removing un-solidified build material 135 located at the different parts that the cleaning stream 155 is applied to.

FIG. 4 is a schematic diagram showing a top view of an example of a cleaning element configuration in a 3D printing module 400. The 3D printing module 400 involves previously disclosed elements from FIG. 1 referred to with the same reference numerals. The 3D printing module comprises the housing 110 and the platform 120 where at least a 3D printed part 130 is to be placed onto for cleaning.

The 3D printing module 400 comprises a plurality of cleaning elements 450A-D in the chamber 115, each of the plurality of cleaning elements 450A-D may be the same as or similar to the cleaning element 150 from FIG. 1. In the example, four cleaning elements 450A-D have been illustrated, one at the top portion of each lateral wall from the housing 110. However, other examples may have more or less cleaning elements. Furthermore, the cleaning elements 450A-D have been illustrated substantially at the middle of each of the lateral walls of the chamber 115, however in other examples they could be located at any position from the lateral walls of the housing 110 without departing from the scope of the present disclosure.

Each of the plurality of cleaning elements 450A-D is coupled to the controller 160 (not shown). The controller 160 is to control the plurality of cleaning elements 450A-D to independently generate cleaning streams 455A-D. In the example, the controller 160 controls a first cleaning element 450A to generate a first cleaning stream 455A, a second cleaning element 450B to generate a second cleaning stream 455B, a third cleaning element 450C to generate a third cleaning stream 455C and a fourth cleaning element 450D to generate a fourth cleaning stream 455D.

In an example, the controller 160 controls the plurality of cleaning elements 450A-D to generate the plurality of cleaning streams 455A-D simultaneously. In another example, the controller 160 controls the plurality of cleaning elements 450A-D to generate the plurality of cleaning streams 455A-D sequentially. In yet another example, the controller 160 controls the plurality of cleaning elements 450A-D to generate the plurality of cleaning streams 455A-D simultaneously for a first period of time, and sequentially for a second period of time.

In the examples above, the term “sequentially” should be interpreted as generating the plurality of cleaning streams 455A-D in a sequence. In the examples herein, the sequence may involve turning on/off of the different cleaning elements 450A-D, controlling the rotation of the cleaning streams 455A-D, controlling the intensity of the cleaning streams 455A-D, and the like.

In an example, a sequence may involve turning on the first cleaning element 450A to generate the first cleaning stream 455A for a first period of time. Then turning off the first cleaning element 450A and turning on the second cleaning element 450B to generate the second cleaning stream 455B for a second period of time. Then turning off the second cleaning element 450B and turning on the third cleaning element 450C to generate the third cleaning stream 455C for a third period of time. And then turning off the third cleaning element 450C and turning on the fourth cleaning element 450D to generate the fourth cleaning stream 455D for a fourth period of time. This sequence may be repeated multiple times. Other examples may involve turning on/off the cleaning elements 450A-D in a different order, with different cleaning streams 455A-D rotations, intensities, and the like.

The controller 160 controls the cleaning elements 450A-D and cleaning streams 455A-D to apply an independent cleaning stream 455A-D to clean the 3D printed part 130. In an example, the cleaning elements 450A-D are configured in such a way that the generated cleaning streams 455A-D are balanced to keep the 3D printed part 130 in the middle of the chamber 115 during cleaning. In another example, however, the cleaning elements 450A-D are configured in such a way that the generated cleaning streams 455A-D are to cause the 3D printed part 130 to move around the platform 120 to enhance the cleaning performance.

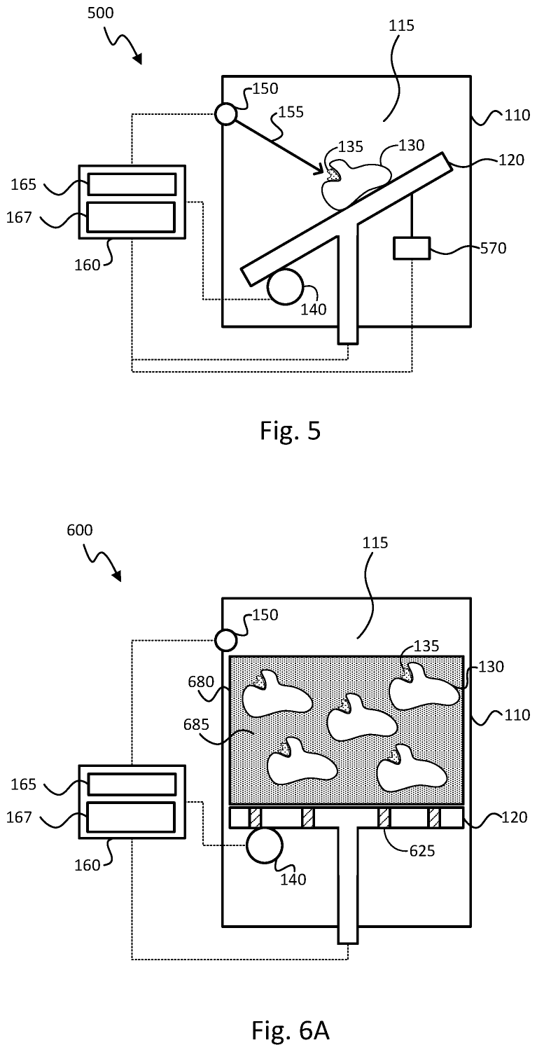

FIG. 5 is a schematic diagram showing an example of a 3D printing module 500 with a tilting mechanism 570. The 3D printing module 500 involves previously disclosed elements from FIG. 1 referred to with the same reference numerals. The 3D printing module 500 comprises the housing 110, the platform 120 where at least a 3D printed part 130 is to be placed onto for cleaning, the vibrating mechanism 140, and the controller 160.

As mentioned above, the 3D printing module 500 further comprises a tilting mechanism 570. The tilting mechanism 570 may be any mechanism suitable for tilting the platform 120, thereby for modifying the orientation of the platform 120 with respect to the air stream 155. In some examples, the tilting mechanism 570 comprises electro-mechanic elements.

The tilting mechanism 570 is coupled to the controller 160. The controller 160 is to control the tilting mechanism to re-orientate the platform 120, and thereby the 3D printed part 130, with respect to the cleaning stream 155, so that the cleaning stream 155 is applied to the un-solidified build material 135 and remove it for cleaning purposes.

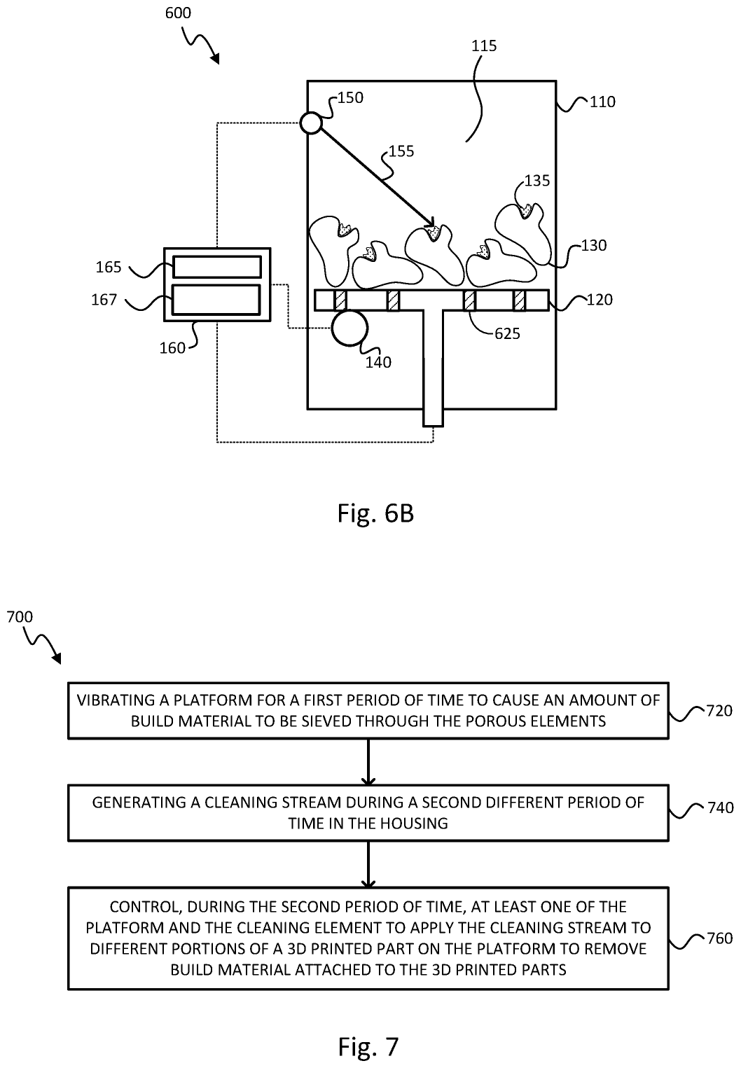

FIGS. 6A and 6B show another example of a cleaning process of a build bed in a 3D printing module 600. FIG. 6A is a schematic diagram showing an example of first stage of the cleaning process and FIG. 6B is another schematic diagram showing an example of a second stage of the cleaning process. The 3D printing module 600 involves previously disclosed elements from FIG. 1 referred to with the same reference numerals or with some modifications. The 3D printing module 600 comprises the housing 110, the platform 120, the vibrating mechanism 140, the cleaning element 150 and the controller 160.

The printing module 600 comprises a build bed receiving interface (not shown) to receive a build bed 680. In some examples, the build bed receiving interface is located at a lateral side of the housing 110 and the build bed is transferred from a transportation unit laterally to the platform 120. In other examples, the build bed receiving interface is located at the top side of the housing 110 and there build bed is transferred from a transportation unit from the top of the housing to the platform 120. In some examples, the controller 160 controls the build platform 120 to move to a high position to assist in the build bed 480 transfer from the transportation unit to the top surface of the platform 120.

The build bed 680 comprises a plurality of 3D printed parts 130 and un-solidified build material. In some examples, the un-solidified build material comprises loose build material 685 and build material 135 attached to the walls of the 3D printed parts 130 (referred also to as attached build material 135). The attached build material 135 is harder to separate from the 3D printed object than the loose build material 685.

The platform 120 comprises a plurality of apertures 625 throughout its surface suitable to remove build material of the build bed 680 from the top surface of the platform 120 to the bottom surface of the platform 120. At the bottom surface of the platform, a build material extraction system may extract the removed build material out of the housing 110. In some examples, the build material extraction system may be a pneumatic conveyance system in fluid communication with a hopper, tank or a container (not shown).

Turning back to FIG. 6A, the build bed 680 is transferred to the housing 110, particularly onto the platform 120. The controller 160 is then to control the vibrating mechanism 140 to vibrate and cause the platform 120 to vibrate for a first period of time. The vibrations of the platform 120 are to remove the un-solidified build material from the build bed 180. The loose build material 685 may be the first to be removed. In some examples, the attached build material 135 may take longer to be removed or may not be removed completely by the effect of vibration.

In an example, the first period of time may be a fixed predefined amount of time. The first fixed predetermined amount of time may be based on the packing degree of the build bed, the expected part quality of the print job, the material, the solidifying technology used, and the like.

In other examples, however, the first period of time may be based on the amount of build material removed. The removed build material is transferred to the hopper which may comprise a load cell coupled to the controller 160. In an example, the controller 160 may detect if the load cell senses an increase of weight of the hopper (and its contents) of a predetermined threshold. In another example, the controller 160 also detects that the weight of the hopper (and its contents) is not increasing which indicates that most of the loose build material 685 has already been removed.

FIG. 6B corresponds to the 3D printing module 600 after the first period of time, in which most part of the loose build material 685 has already been removed. After the first period of time, the platform 120 may comprise a plurality of 3D parts 130 with attached build material 135 that needs to be cleaned.

The controller 160 may then control the cleaning element 150 (or plurality of cleaning elements) to generate the cleaning stream 155 in the housing 110 during a second different period of time. In some examples, the first period of time and the second period of time are independent periods of time. In other examples, the first period of time and the second period of time are partially overlapping.

In an example, the controller 160 is also to control, during the second period of time, the platform 120 to move, so that the cleaning stream 155 is applied to different portions of the 3D printed parts 130 to remove at least part of the attached build material 135 (see, e.g., examples relating to FIG. 3A).

In another example, the controller 160 is to control, during the second period of time, the cleaning element 150 and/or a shutter (not shown), to generate and direct a rotatable cleaning stream 155 to different portions of the 3D printed parts 130, and thereby remove at least part of the attached build material 135 (see, e.g., examples relating to FIG. 3B).

In yet another example, the controller 160 is to control, during the second period of time, the platform 120, the cleaning element 150 and/or the shutter, to move and thereby cause the cleaning stream 155 to be applied to different portions of the 3D printed parts 130 to remove at least part of the attached build material 135 attached thereto (see, e.g., examples relating to FIG. 3C).

Additionally, the controller 160 may also control the vibrating mechanism 140 to cause the platform 120 to vibrate during the second period of time.

In some additional examples, the controller 160 may also be coupled to a tilting mechanism to tilt the platform 120.

FIG. 7 is a flowchart of another example method 700 for removing un-solidified build material in the 3D printing module 600. Method 700 may involve previously disclosed elements from FIGS. 6A and 6B referred to with the same reference numerals. In some examples, method 700 may be executed by the controller 160 from FIGS. 6A and 6B.

The method 700 may start when a build bed 680 is placed onto the platform 120 in the housing 110 of the 3D printing module 600.

At block 720, the controller 160 may control the vibrating mechanism 140 to cause the platform 120 to vibrate for the first period of time to cause an amount of build material (e.g., loose build material 685) to be removed through the apertures 625 from the platform 120.

At block 740, the controller 160 may control the cleaning element 150 to generate a cleaning stream 155 during a second different period of time in the housing 110.

At block 760, the controller 160 controls, during the second period of time, at least one of the platform 120 and the cleaning element 150 to apply the cleaning stream 155 to different portions of a 3D printed part 130 on the platform 120, and thereby remove build material attached 135 to the 3D printed parts 130.

As used herein, the terms “substantially” and “about” are used to provide flexibility to a range endpoint by providing a degree of flexibility. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printing module to remove un-solidified build material attached to a 3D printed part, comprising:
a platform within a housing to support a 3D printed part;
a vibrating mechanism to vibrate the platform;
a cleaning element to apply a cleaning stream within the housing to clean the 3D printed part; and
a controller to:
   vibrate the platform;
   generate a cleaning stream in the housing; and
   control at least one of the platform and the cleaning element to apply the cleaning stream to different portions of a 3D printed part on the platform.

Feature set 2: A 3D printing module with feature set 1, wherein the cleaning element is in a position towards a top portion of the housing and generates the cleaning stream towards the platform.

Feature set 3: A 3D printing module with any preceding feature set 1 to 2, wherein the controller is to control the platform to move vertically within the housing.

Feature set 4: A 3D printing module with any preceding feature set 1 to 3, wherein the controller is to control the cleaning stream to move in a rotatable manner.

Feature set 5: A 3D printing module with any preceding feature set 1 to 4, wherein the cleaning element is fixed with respect to the housing, and the controller is to control the platform to move vertically during a cleaning operation.

Feature set 6: A 3D printing module with any preceding feature set 1 to 5, wherein the controller is further to: (i) control the platform to move to a predetermined position with respect to the housing; and (ii) control the cleaning element to move in a rotatable manner while the platform is maintained in the predetermined position, such that the cleaning stream is applied to different parts of a 3D printed part during a cleaning operation.

Feature set 7: A 3D printing module with any preceding feature set 1 to 6, wherein the controller is to move the cleaning stream and the build platform such that the cleaning stream is applied to different parts of the 3D printed part during a cleaning operation.

Feature set 8: A 3D printing module with any preceding feature set 1 to 7, wherein the cleaning element is an airknife.

Feature set 9: A 3D printing module with any preceding feature set 1 to 8, further comprising a plurality of cleaning elements in the housing coupled to the controller, the controller to control each cleaning element to apply an independent cleaning stream in a sequence to clean the 3D printed part.

Feature set 10: A 3D printing module with any preceding feature set 1 to 9, wherein the controller is to apply the cleaning stream in a predetermined manner.

Feature set 11: A 3D printing module with any preceding feature set 1 to 10, further comprising a tilting mechanism and wherein the controller is to control the tilting mechanism to modify the orientation of the platform with respect to the air stream.

Feature set 12: A 3D printing module with any preceding feature set 1 to 11, further comprising: (i) a build bed receiving interface to receive a build bed on the platform, the build bed to comprise un-solidified build material and 3D printed parts; (ii) a plurality of apertures in the platform to remove the un-solidified build material; (iii) a hopper to receive the removed un-solidified build material; and (iv) the controller to: (iv.i) cause the vibrating mechanism to vibrate the platform for a first period of time to remove un-solidified build material to the hopper upon receiving a build bed on the platform through the build bed receiving interface, (iv.ii) generate the cleaning stream during a second different period of time in the housing, (iv.iii) control, during the second period of time, at least one of the platform and the cleaning element to apply the cleaning stream to different portions of 3D printed parts on the platform to remove build material attached to the 3D printed parts.

Feature set 13: A method comprising:
vibrating a vibrating mechanism to vibrate a platform from a 3D printing module housing;
generating a cleaning stream in the housing by a cleaning element; and
moving at least one of the platform and/or the cleaning element to apply the cleaning stream to different portions of a 3D printed part located on the platform.

Feature set 14: A method with feature set 13, further comprising tilting the platform through a tilting mechanism.

Feature set 15: A 3D printing apparatus comprising:
a platform within a housing with apertures, the platform to receive a build bed thereon including 3D printed parts and un-solidified build material;
a vibrating mechanism to vibrate the platform;
a cleaning element to apply a cleaning stream within the housing to clean the 3D printed parts; and
a controller to:
vibrate the platform for a first period of time to remove an amount of build material through the apertures of the platform;
generate a cleaning stream during a second different period of time in the housing; and
control, during the second period of time, at least one of the platform and the cleaning element to apply the cleaning stream to different portions of a 3D printed part on the platform to remove build material attached to the 3D printed parts.

What it is claimed is:

1. A 3D printing module to remove un-solidified build material attached to a 3D printed part, the 3D printing module comprising:
a platform within a housing to support a 3D printed part;
a vibrating mechanism to vibrate the platform;
a cleaning element to apply a cleaning stream within the housing to clean the 3D printed part; and
a controller to:
vibrate the platform;
generate a cleaning stream in the housing; and
control at least one of the platform and the cleaning element to apply the cleaning stream to different portions of a 3D printed part on the platform.

2. The 3D printing module of claim 1, wherein the cleaning element is in a position towards a top portion of the housing and is to generate the cleaning stream towards the platform.

3. The 3D printing module of claim 1, wherein the controller is to control the platform to move vertically within the housing.

4. The 3D printing module of claim 1, wherein the controller is to control the cleaning stream to rotate.

5. The 3D printing module of claim 1, wherein the cleaning element is fixed with respect to the housing, and the controller is to control the platform to move vertically during a cleaning operation.

6. The 3D printing module of claim 1, wherein the controller is further to:
control the platform to move to a predetermined position with respect to the housing; and
control the cleaning element to rotate while the platform is maintained in the predetermined position, such that the cleaning stream is applied to different parts of a 3D printed part during a cleaning operation.

7. The 3D printing module of claim 1, wherein the controller is to move the cleaning stream and the build platform such that the cleaning stream is applied to different parts of the 3D printed part during a cleaning operation.

8. The 3D printing module of claim 1, wherein the cleaning element is an airknife.

9. The 3D printing module of claim 1, further comprising a plurality of cleaning elements in the housing coupled to the controller, the controller to control each cleaning element to apply an independent cleaning stream in a sequence to clean the 3D printed part.

10. The 3D printing module of claim 1, wherein the controller is to control the cleaning element to generate the cleaning stream as a series of pulses of a predetermined period.

11. The 3D printing module of claim 1, further comprising a tilting mechanism and wherein the controller is to control the tilting mechanism to modify the orientation of the platform with respect to the air stream.

12. The 3D printing module of claim 1, further comprising:
a build bed receiving interface to receive a build bed on the platform, the build bed to comprise un-solidified build material and 3D printed parts;
a plurality of apertures in the platform to remove the un-solidified build material;
a hopper to receive the removed un-solidified build material;
the controller to:
cause the vibrating mechanism to vibrate the platform for a first period of time to remove un-solidified build material to the hopper upon receiving a build bed on the platform through the build bed receiving interface;
generate the cleaning stream during a second different period of time in the housing; and
control, during the second period of time, at least one of the platform and the cleaning element to apply the cleaning stream to different portions of 3D printed parts on the platform to remove build material attached to the 3D printed parts.

13. A method comprising:
vibrating a vibrating mechanism to vibrate a platform from a 3D printing module housing;
generating a cleaning stream in the housing by a cleaning element; and
moving at least one of the platform and/or the cleaning element to apply the cleaning stream to different portions of a 3D printed part located on the platform.

14. The method of claim 13 further comprising tilting the platform through a tilting mechanism to modify the orientation of the 3D printed part with respect to the cleaning stream.

15. A 3D printing apparatus comprising:
a platform within a housing with apertures, the platform to receive a build bed thereon including 3D printed parts and un-solidified build material;
a vibrating mechanism to vibrate the platform;
a cleaning element to apply a cleaning stream within the housing to clean the 3D printed parts; and
a controller to:
vibrate the platform for a first period of time to remove an amount of build material through the apertures of the platform;
generate a cleaning stream during a second different period of time in the housing; and
control, during the second period of time, at least one of the platform and the cleaning element to apply the cleaning stream to different portions of a 3D printed part on the platform to remove build material attached to the 3D printed parts.
